(19) United States
(12) Patent Application Publication
(10) Pub. No.: US 2004/0074272 A1
(43) Pub. Date: Apr. 22, 2004

(54) Controlled release urea product and method of preparing said product

(76) Inventors: Fernando Basile De Castro, Campinas (BR); Peter Stockhoff, Dorsten (DE)

Correspondence Address: SHAPIRO COHEN, P.O. BOX 3440, STATION D, OTTAWA, ON, K1P6P1, CA

(21) Appl. No.: 10/468,771

(22) PCT Filed: Mar. 20, 2002
(86) PCT No.: PCT/BR02/00043

(30) Foreign Application Priority Data
Mar. 23, 2001 (BR) PI 0101344-0

(51) Int. Cl. C05C 9/00

(52) U.S. Cl. 71/28

(57) ABSTRACT

The present invention relates to a controlled-release urea product and method of prepaing said product, which consists of urea coated with a primer of cement or an insoluble metal salt and one or more coating layers of a 20-50% rosin gum solution in fatty acid or vegetable oils at 20-80° C., and that the concentration of rosin gum in the said product may vary from 2 to 15%, and that inorganic materials such as magnesium oxide are applied in between layers of rosin gum at an inclusion level of 2-20% of said product.

The present invention relates to a product containing controlled-release urea and a method of preparing said product.

Controlled-release urea (CRU) or slow release urea products can be used in several applications such as fertilizers and animal feeds. Generally, CRU products contain rather large quantities of inert coating materials. If the CRU product is used as a feed additive the said inert coating material must be approved for feed application. With regards to the use of CRU as a fertilizer there is an increasing demand for environmentally acceptable coatings such as biodegradable coatings.

Market acceptance of controlled-release products has been rather limited and it is mainly due to the following reasons:

a) high cost of coating materials and need to use high inclusion rates of such coating materials;

b) production of controlled release products can be complicated and expensive.

Urea is a rich source of non-protein nitrogen (NPN) and largely used as a feed additive for ruminants. Ideally urea is converted into microbial protein and thereby it supplies additional protein to the host animal. However, an imbalance in the rate of N supply for fermentable carbohydrates to the rumen can result in excessive ammonia generation and high rumen ammonia concentration. Rumen microbial growth and fibre degradation can be negatively affected by too low rumen ammonia levels, whilst too high rumen ammonia levels can cause excessive N losses and in severe cases may cause toxicity. Conventional “unprotected” urea is rapidly solubilized in the rumen which in turn causes a sharp increase in rumen ammonia level shortly after the 4 meals. Therefore the inclusion of urea in ruminant diets must follow specific criteria and should not exceed certain levels. Urea N is best utilised by ruminants in slow release form. Such slow release minimises variation in rumen ammonia concentration, which in turn improves the overall urea utilisation, decreases the risk of urea-related toxicity, and finally allows one to incorporate higher quantities of urea in the diet.

Although several controlled release urea technologies have been developed the number of commercial successes is rather small. The main reasons are believed to be the high production/raw material cost, use of coating materials which are innapropriate for a given application and low efficiency with regards to urea protection. The latter is commonly associated with weakness of the coating layer, which does not stand handling and therefore breaks up and detaches from the urea particle. Another common problem associated with the poor performance of coated controlled release products is the existence of pin holes in the coating layers.

WO98/2730 patent describes a process to produce a feed grade controlled release urea product. The product consists of a lignin-urea matrix (LU) containing 75-15:25-85% urea:lignin mixture. The LU matrix may be coated with lanonin or resin to improve urea protection. As for the matrix product, i.e. uncoated ligin-urea, urea protection increases with lignin inclusion rate in the matrix.

WO96/01794 discloses a controled-release urea product in fertilizer application. The said product consists of a matrix of water soluble fertilizer such as urea, a cement of the type magnesium oxychloride or magnesium oxysulphate, and one or more carboxylic acids or its related salts. Extra protection may be obtained by coating the said matrix with cement layers. The said invention is only effective when large amounts of cement are incorporated both in the urea matrix and coating layers and therefore the process is not economically interesting.

Another matrix-type controlled release fertilizer is described in WO96/18591 patent. Biodegradable resins such as rosin gum, wax and aliphatic polyesters are mixed with a fertilizer and extruded under specific conditions. Extruded matrices of controlled-release fertilizer containing 50-70% urea and 50-30% rosin gum or wax may be obtained in this process.

ES8507088 patent discloses a fertilizer coating process using primarily rosin gum. Rosin gum is dispersed is organic solvents and applied as a coating layer on to fertilizers, which is subsequently coated with inorganic salts, such as calcium phosphate or calcium carbonate. The end product is dried and the organic solvent recycled. Organic solvents used according to this process can be ethanol, toluene and benzene, and concentration of rosin gum may vary between 350 to 450 g per litre of solvent. The concentration of rosin gum in the end product varies from 10 to 50%, but preferably ranges from 15 to 45%. Such high inclusion level of rosin gum substantially increases costs and makes the said process less competitive.

The main objective of the present invention was to arrive at an effective controlled-release urea product consisted of high levels of urea, which could be used in ruminant feeding as a means to improve the utilisation of urea nitrogen and its safety with regards to the animal health.

Another objective of the present invention was to arrive at a product containing controlled-release urea, which was more resistant to physical forces such as those present in feed manufacture, handling and transportation.

A further objective was to arrive at a simple and economically sound process, which uses low cost raw materials.

In the search for a solution to the above-mentioned problems the inventors evaluated prior art and even tested some of the described ideas for obtaining controlled-release urea products. Matrix-type controlled release fertilizers as well as matrix-type lignin-urea feed supplement were thoroughly investigated without succeding in obtaining the desired product. The amount of inert materials in such products was found to be unacceptably high, particularly in the case of rosin gum, which in turn made the said products too expensive. Another problem was that the coating layers easily cracked during handling of the product and thereby their slow release properties were completely compromised even before the actual application.

It was therefore concluded that none of the prior art was suitable to produce a feed grade controlled-release urea.

The inventors then started a series of experiments in order to arrive at an innovative and efficient technology.

The use of rosin gum a the solely raw material for coating, as suggested in prior inventions, was proved to be rather difficult. The problems are associated with the stickness of molten rosin and the melting point of the rosin which is rather close to that of urea. Accordingly, it would be more practical to dissolve rosin in a carrier such as acetone, alcohol, toluene, benzene, etc, and then spray it on to urea particles. However, such solvents might cause problems in the industrial production and one would want to avoid the use of such flammable materials.

It was then considered one option which would be highly benefitial from the point of view of cost and nutritive value. It was discovered that rosin gum, which happens to be compatible with fatty acids or vegetable oils, could be dissolved in such compounds up to 20-50% weight basis and further sprayed on to urea particles. Fatty acids such as oleic acid or soy oil or other vegetable oils, or even animal fat would be retained in the end-product, and act both as an aditional hydrophobic layer and as an extra source of energy and essential fatty acids to the host animal. A further advantage is the simplicity of the process, which no longer uses flammable compounds and requires no recycling units for solvents.

Several experiments have been carried out and indicated that fatty acids alone and mixtures of fatty acids of 4 to 22 carbons and vegetable oils are potentially interesting products to disperse rosin gum into. The fatty acid or oil temperature to dissolve such rosin gum should be in the range of 50-130° C., and the rosin gum solution should be sprayed on to urea particles at a tempetature varying from 20 to 80° C. Results were very promising as the inclusion of fatty acid or oil did not compromise urea release rate compared to previous technologies using ethanol as a solvent for rosin gum. A further advantage of this new process was that it enabled one to apply more than one coating layer of rosin gum separated by layers of, for instance, magnesium oxide in powder form. Besides magnesium oxide, other alkaline oxides and carbonates may also be used as intermediate layers so as to form stable cement layers in between the layers of rosin gum.

The term rosin gum herein referred to is generally accepted as a natural product extracted from trees, also referred to as colophony or simply rosin and it is consisted primarily of a mixture of abietic acids and other related compounds. This resin is not polymerised and it is commercially available as an amorphous and dry product. Its melting point may vary from 100 to 150° C. Sinthetic resins may also be used according to this invention provided they are approved for feed applications.

Several types of cement layers may be used provided that the raw materials are feed approved. The preferred choice of cement is magnesium-type cements, such as magnesium oxyphosphates or oxysulphates.

Other nutrients of the type macro and microminerals and vitamins may be added to the formulation, which mat be beneficial both to improve the overall nutritive value and supply such nutrients in slow relase form.

Although the present invention is primarily targeted at feed application, as described in following examples, it can also be used in fertilizer application.

Controlled-release urea product according to this invention is made up of urea, which may be pre-coated with a cement or an insoluble inorganic salt layer (“primer”), followed by coating layers of rosin gum added between 2 to 15% weight basis of final product.

The end-product may consist of one or more layers of rosin gum, which should have intermediate layers of an inorganic powder.

The end-product should contain 2-20% of inorganic powder. Vitamins and other macro and microminerals may also be part of the end-product.

Spraying is the prefered method to apply the coating layer consisted of rosin gum dissolved in fattys acids or vegetable oils.

The prefered method to produce the said controlled-release urea product is to coat urea particles with a primer of magnesium-type cement or an insoluble metal salt, which is then further coated with at least one layer of a 20-50% rosin gum solution in fatty acid or vegetable oil at a temperature varying from 20 to 80° C.

Powder products such as magnesium oxide should be applied directly on to layers of rosin gum.

The following examples and figures describe further details of the present invention.

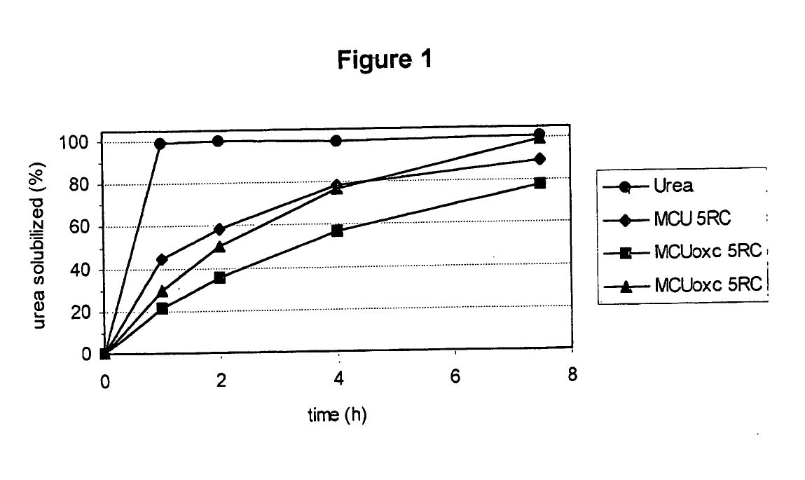

FIG. 1: Effect of primer and rosin gum on urea solubility in vitro.

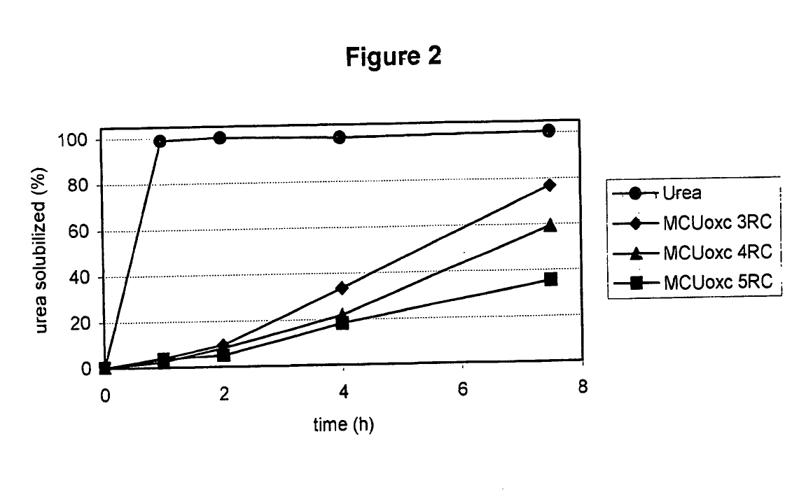

FIG. 2: Effect of primer, rosin gum and limited quantities of calcium carbonate on urea solubility in vitro.

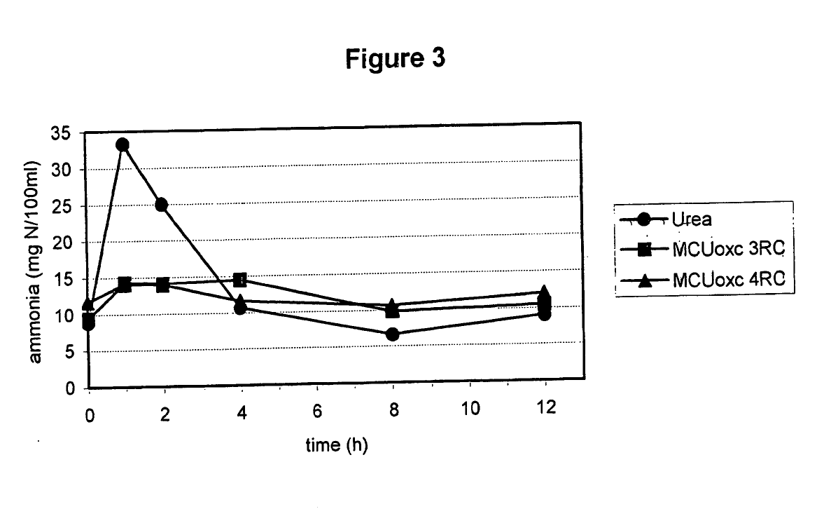

FIG. 3: In vivo effect (rumen ammonia profile) of incorporating controlled-release urea product into a ruminant diet.

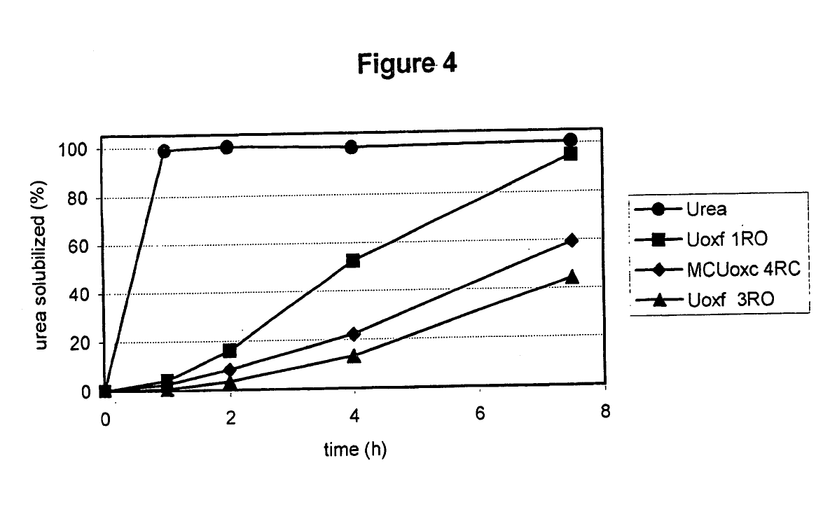

FIG. 4: Effect of dissolving rosin gum in fatty acid as an alternative and more efficient technology to produce a controlled-release urea product.

### EXAMPLE 1

This example shows the effect of 2 types of coating on the solubility of prilled urea. The coating layers consisted of rosin only or a combination of primer and rosin. Products produced in this example as well as in examples 2 and 3 were evaluated by an in vitro solubility assay. Fifty mg urea was incubated in 50 ml water at 39° C. Samples (1 ml) were taken after 1, 2, 4 and 7.5 h incubation. Urea concentration was estimated by spectrophotometry. Preliminary studies indicated that the above-mentioned protocol produced results which were highly correlated with those obtained from other procedures such as artificial saliva or rumen fluid.

The primer was made in situ with an oxyphosphate cement by applying phosphoric acid and magnesium oxide on to the surface of prilled urea. Rosin gum was dissolved in acetone 30% w/v basis and applied on to prilled urea with or without a primer coating. It was noticed that when more than one layer of rosin was applied it was beneficial to apply an inorganic powder between rosin layers. In the present experiment calcium carbonate was tic inorganic powder of choice. Results are shown in Table 1, whereby rosin+calcium carbonate layer is referred to as RC. Figures before RC mean the number of coating layers applied.

Results indicated that prilled urea may be protected with rosin only. However, large quantities of rosin should be applied to achieve an efficient protection. Conversely, better urea protection and less rosin was needed when primer was used.

### EXAMPLE 2

This example shows the effect of coating a matrix of magnesium cement urea (MCU) with rosin and calcium carbonate (RC) with or without primer of oxychloride (oxc) or oxysulphate (oxs). Calcium carbonate was applied as a dry powder to facilitate further spraying of rosin. Results are shown in Table 2 and FIG. 1.

Data indicated that urea protection by cement-urea matrix was not effective. Rosin coating decreased urea solubility, but as indicated in previous example protection was significantly more effective when primer was used in combination with rosin. It is worth highlighting that the products herein described do not exhibit ideal properties for feed application. The inventors then looked for methods to improve product performance and urea concentration in the end-product.

### EXAMPLE 3

This example shows the effect of reducing the amount of calcium carbonate on urea solubility. A series of treatments were carried out on magnesium cement-urea matrices. Such matrices were coated with primer of oxychloride and then coated with 3, 4 or 5 layers of rosin calcium carbonate. Calcium carbonate was applied in sufficient amounts to completely cover the matrix granules and improve the adhesion of the subsequent rosin layer. Results are described in Table 3 ansd FIG. 2.

Table 3 clearly indicates that the combination of oxychloride cement primer, rosin and limited quantities of calcium carbonate was highly effective to protect urea, which could be used in ruminant feeding.

### EXAMPLE 4

This example shows the in vivo effects of feeding ruminants with controlled release urea products. Samples consisted of prilled urea-cement matrix coated with a primer of the type oxychloride cement followed by 3 or 4 layers of rosin and calcium carbonate.

The experiment was carried out with sheep fitted with rumen cannulae. Sheep were fed on a control diet of 63% grass hay and 37% of unmollassed sugarbeet pulp. Control diet was then supplemented with 1.3% urea (or urea equivalent in the is form of a controlled-release product) and added directly into the rumen to avoid excess chewing, which is known to be more intense in sheep compared to cattle. Data from the feeding trials are described in Table 4 and FIG. 3.

Sheep fed on controlled-release urea, MCUoxc 3RC and 4RC treatments, had a different rumen ammonia profile compared to urea treatment. Diets containing controlled-release urea had signficantly lower ammonia concentration 1-2 h after feeding and higher rumen ammonia concentration 4 h after feeding, when compared to urea treatment. Such difference in rumen ammonia profile could have three immediate positive effects:

a) decrease risk of toxicity caused by feeding large amoutns of urea;

b) improve overall utilization of urea nitrogen;

c) improve rumen microbial activity and feed utilization.

### EXAMPLE 5

This example describes the preferred embodiment to carry out the present invention.

Urea particles were coated with an oxyphosphate cement primer made up in situ with phosphoric acid and magnesium oxide, as described in previous examples. Urea particles were then sprayed with a 30% rosin solution in oleic acid at 60° C. thereby making a rosin-oleic acid layer herein referred to as RO. One of three RO layers were applied, and small amounts of magnesium oxide were incorporated in between RO layers. Both rosin and oleic acid were firmly glued on to urea particles and formed a homogeneous coating layer.

End-products had high urea content and exhibited interesting controlled-release properties. Results comparing MCUoxc 4RC from Example 3 and the two samples (Uoxf 1RO and Uoxf 3RO) from this example are shown in Table 5 and FIG. 4.

An example of the final composition of one prefered embodiment (Uoxf 1RO) is described below:

| | |
|---|---|
| Urea: | 68.4% |
| Phosphoric acid: | 1.5% |
| Magnesium oxide: | 17.3% |
| Oleic acid: | 9.1% |
| Rosin: | 3.7% |

Differently from other prior art the above-mentioned controlled release urea product contains only 3.7% of rosin, which is an inert material and therefore has no added nutritive value. All other raw materials are potentially sources of energy or minerals and therefore add value to the end-product.

TABLE 1

| | | | | Urea solubilized (%) | | | |
|---|---|---|---|---|---|---|---|
| | Coating layer (%) | | | Incubation time (h) | | | |
| Sample | Urea | Rosin | CaCO₃ | 1 | 2 | 4 | 7.5 |
| Urea | 100 | 0 | 0 | 98.9 | 100.1 | 99.3 | 100.6 |

Prilled urea without primer (U) - 96.6% urea

| | | | | | | | |
|---|---|---|---|---|---|---|---|
| U4RC | 71.9 | 17.1 | 8.4 | 76.6 | 87.8 | 89.5 | 96.4 |
| U5RC | 57.3 | 23.6 | 17.1 | 52.6 | 77.9 | 99.7 | 98.7 |

Prilled urea with oxyphosphate cement primer (U-O) 85.5% urea

| | | | | | | | |
|---|---|---|---|---|---|---|---|
| U-O 5RC | 54.7 | 7.5 | 28.5 | 16.9 | 34.4 | 87.7 | 96.4 |

TABLE 2

| | | | | Urea solubilized (%) | | | |
|---|---|---|---|---|---|---|---|
| | Coating layer (%) | | | Incubation time (h) | | | |
| Sample | Urea | Rosin | CaCO₃ | 1 | 2 | 4 | 7.5 |
| Urea | 100 | 0 | 0 | 98.9 | 100.1 | 99.3 | 100.6 |
| MCU | 69.6 | 0 | 0 | 96.5 | 98.6 | 100.1 | 99.9 |
| MCU 5RC | 42.2 | 4.6 | 34.8 | 45.0 | 58.8 | 78.6 | 89.4 |
| MCUoxc 5RC | 36.0 | 7.7 | 34.6 | 21.9 | 35.8 | 56.8 | 77.6 |
| MCUoxs 5RC | 32.0 | 14.5 | 29.3 | 30.0 | 50.2 | 77.2 | 99.2 |

TABLE 3

| | | | | Urea solubilized (%) | | | |
|---|---|---|---|---|---|---|---|
| | Coating layer (%) | | | Incubation time (h) | | | |
| Sample | Urea | Rosin | CaCO₃ | 1 | 2 | 4 | 7.5 |
| Urea | 100 | 0 | 0 | 98.9 | 100.1 | 99.3 | 100.6 |
| MCUoxc 3RC | 49.0 | 5.1 | 9.0 | 4.1 | 9.6 | 33.6 | 76.6 |
| MCUoxc 4RC | 48.6 | 4.2 | 10.5 | 2.5 | 8.3 | 22.0 | 59.1 |
| MCUoxc 5RC | 43.8 | 11.9 | 11.1 | 3.7 | 5.1 | 18.4 | 35.4 |

TABLE 4

| | Treatment | | |
|---|---|---|---|
| Sampling time | Urea | MCUoxc 3RC | MCUoxc 4RC |
| (h after feeding) | Rumen ammonia (mg N/100 ml) | | |
| 0 | 8.8 | 9.4 | 11.7 |
| 1 | 33.3 | 14.3 | 14.1 |
| 2 | 25.0 | 14.1 | 14.0 |
| 4 | 10.7 | 14.5 | 11.6 |
| 8 | 6.6 | 9.8 | 10.6 |
| 12 | 9.0 | 10.5 | 12.0 |

TABLE 5

| | | Urea solubilized (%) | | | |
|---|---|---|---|---|---|
| | | Incubation time (h) | | | |
| Sample | Urea (%) | 1 | 2 | 4 | 7.5 |
| Urea | 100 | 98.9 | 100.1 | 99.3 | 100.6 |
| MCUOxc 4RC | 48.6 | 2.5 | 8.3 | 22.0 | 59.1 |
| Uoxf 1RO | 68.4 | 3.9 | 16.2 | 53.2 | 95.0 |
| Uoxf 3RO | 62.4 | 0.7 | 3.3 | 13.2 | 44.0 |

1. Controlled-release urea product and method of preparing said product”, characterized by that controlled release product consists of urea pre-coated with a primer of the type cement or an insoluble metal salt, and one or more coating layers of rosin gum in fatty acid ou rosin gum in vegetable oil with intermediate layers of inorganic compounds in powder form.

2. Controlled-release urea product and method of preparing said product” according to claim 1, characterized by that primer made up of cement or insoluble metal salt improves adhesion between urea particles and rosin gum layers.

3. Controlled-release urea product and method of preparing said product” according to claim 1, characterized by that rosin gum is dissolved in fatty acid or vegetable oil prior to its incorporation into the said product.

4. Controlled-release urea product and method of preparing said product” according to claim 1, characterized by that fatty acids and vegetable oils improve rosin gum processability and nutritive value of said product.

5. Controlled-release urea product and method of preparing said product” according to claim 1, characterized by that 2 to 15% rosin gum is incorporated into said product and at least one inorganic compound, such as magnesium oxide, in powder form is incorporated in between layers of rosin gum.

6. Controlled-release urea product and method of preparing said product” according to claim 1, characterized by that coating layer made up of cement should be of the type oxyphosphate, oxysulphate or oxychloride, and is incorporated into the said product from 1 to 10% weight basis.

7. Controlled-release urea product and method of preparing said product” according to claim 1, characterized by that the last coating layer is made up of a combination of rosin gum in fatty acid or vegetable oil and elemental sulphur, and that 3 to 7% of elemental sulphur is added to the said product.

8. Controlled-release urea product and method of preparing said product” according to claim 1, characterized by that said product consists of 2 to 20% of an inorganic compound in powder form.

9. Controlled-release urea product and method of preparing said product” according to claim 1, characterized by that vitamins, microminerals and macrominerals may be incorporated in between layers of rosin gum.

10. Controlled-release urea product and method of preparing said product” according to claim 1, characterized by that primer layer of insoluble metal salts is made in situ by reacting inorganic acids and magnesium or calcium carbonates or their respective oxides, or preferably phosphoric acid and magnesium oxide.

11. Controlled-release urea product and method of preparing said product” according to claim 1, in that the method of preparing said product is characterized by that urea particles are uniformly pre-coated by spraying a primer of cement or insoluble metal salt followed by spraying a 20-50% rosin gum solution in fatty acid or vegetable oil at 20-80° C., and having layers of magnesium oxide in between rosin gum layers.

12. Controlled-release urea product and method of preparing said product” according to claim 1, characterized by that the said product containing a controlled-release urea is used as a protein supplement in ruminant feeding, and may be incorporated into compound feeds, mineral supplement, high protein and high energy feed ingredients, vitamin premixes, feed eficiency improvers, and essential fatty acids.

13. Controlled-release urea product and method of preparing said product” according to claim 1, characterized by that the said product containing a controlled-release urea is used as a protein supplement in ruminant feeding to improve rate of urea utilization and minimize urea toxicity.

14. Controlled-release urea product and method of preparing said product” according to claim 1, characterized by that the said product containing a controlled-release urea is used as a plant fertilizer, added to micromineral mixes and pesticides.
